(19) United States
(12) Patent Application Publication
(10) Pub. No.: US 2021/0098137 A1
(43) Pub. Date: Apr. 1, 2021

(54) SMART MEDIA DEVICE

(71) Applicant: ARRIS Enterprises LLC, Horsham, PA (US)

(72) Inventors: Brian CARROLL, Horsham, PA (US); Richard MOORE, JR., Horsham, PA (US); Mallika SUBRAMANYAM, Horsham, PA (US); Joseph PETRY, Horsham, PA (US)

(21) Appl. No.: 17/036,025

(22) Filed: Sep. 29, 2020

Related U.S. Application Data
(60) Provisional application No. 62/908,080, filed on Sep. 30, 2019.

(51) Int. Cl. G16Y 40/35; H04L 12/28; G16Y 10/80; G06F 3/16; G06F 21/62

(52) U.S. Cl. CPC G16Y 40/35; H04L 12/2832; G06F 21/6245; G06F 3/167; G16Y 10/80

(57) ABSTRACT

Increasingly, multiple users and multiple network devices are connecting to or requesting access to and/or from network resources. Users are increasingly expanding the number of network devices connected to a network. For example, a Home Network Environment (HNE) can have multiple networked devices connected to a single network. Each network device has its own interface and each network device is controlled via this interface which is generally located at the network device. A smart media device (SMD) can provide a centralized control for the multiple network devices and access to and/or from the multiple network resources. The SMD can provide control of one or more Internet of Things devices communicatively coupled to the SMD.

### BACKGROUND

Increasingly, multiple users and multiple network devices are connecting to or requesting access to and/or from network resources. Users are increasingly expanding the number of network devices connected to a network. For example, a Home Network Environment (HNE) can have multiple networked devices connected to a single network. Each network device has its own interface and each network device is controlled via this interface which is generally located at the network device. Therefore, there is a need to provide a centralized control of each of the network devices with a single device.

### SUMMARY

According to aspects of the present disclosure there are provided novel solutions for a smart media device that provides new, more-immersive, user engagement techniques for controlling, interacting with, using, and experiencing services provided by service providers, for example, from a centralized location.

An aspect of the present disclosure provides a smart media device (SMD) that comprises a network interface, a microphone, a camera, a display, a memory that stores one or more computer-readable instructions, and a processor. The processor is configured to execute the one or more computer-readable instructions to perform one or more operations to receive, via the network interface, data from a service provider, receive, via the microphone, a first user command, wherein the first user command comprises audio, receive, via the camera, a second user command, wherein the second user comprises a visual movement, output, to the display, the data, providing a two-way wireless communication with an Internet of things (IoT) equipped device, and control the IoT equipped device based, at least in part, on the first user command, the second user command or both.

In an aspect of the present disclosure, the processor of the SMD is further configured to execute the one or more computer-readable instructions to further perform the one or more operations to detect an activation command and activate in response to the activation command.

In an aspect of the present disclosure, the activation command is detected via the microphone, the camera, or both.

In an aspect of the present disclosure, the processor of the SMD is further configured to execute the one or more computer-readable instructions to further perform the one or more operations to determine whether the activation command is associated with a smart assistant or a local function.

In an aspect of the present disclosure, the processor is further configured to execute the one or more computer-readable instructions to further perform one or more operations to in response to the determination that the activation command is associated with the smart assistant, identify the smart assistant associated with the activation command, and wherein activating in response to the activation command comprises activating the smart assistant.

In an aspect of the present disclosure, the processor is further configured to execute the one or more computer-readable instructions to further perform one or more further operations to in response to the determination that the activation command is associated with the local function, provide an output command to a local device.

In an aspect of the present disclosure, the SMD further comprises a voice privacy button, wherein the voice privacy button is an electronic persistent switch that does not allow for software control.

An aspect of the present disclosure provides a method for receiving one or more commands by a smart media device (SMD). The method comprising: receiving, via a network interface, data from a service provider, receiving, via a microphone, a first user command of the one or more commands, wherein the first user command comprises audio, receiving, via a camera, a second user command of the one or more commands, wherein the second user comprises a visual movement, outputting, to a display, the data, providing a two-way wireless communication with an Internet of things (IoT) equipped device, and controlling the IoT equipped device based, at least in part, on the first user command, the second user command or both.

In an aspect of the present disclosure, the method further comprises detecting an activation command and activating in response to the activation command.

In an aspect of the present disclosure, the method further comprises that the activation command is detected via the microphone, the camera, or both.

In an aspect of the present disclosure, the method further comprises that the microphone is controlled by a voice privacy button, wherein the voice privacy button is an electronic persistent switch that does not allow for software control.

In an aspect of the present disclosure, the method further comprises determining whether the activation command is associated with a smart assistant or a local function.

In an aspect of the present disclosure, the method further comprises in response to the determination that the activation command is associated with the smart assistant, identifying the smart assistant associated with the activation command, and wherein activating in response to the activation command comprises activating the smart assistant.

In an aspect of the present disclosure, the method further comprises in response to the determination that the activation command is associated with the local function, providing an output command to a local device.

An aspect of the present disclosure provides a non-transitory computer-readable medium of a smart media device (SMD) for storing a program for receiving one or more commands. The program when executed by a processor of the SMD, causes the SMD to perform one or more operations including the steps of the methods described above.

Thus, according to various aspects of the present disclosure described herein, it is possible to provide by a smart media device a centralized control of one or more network devices in a network, for example, a home network. In this way, the user is provided an enhanced network experience by having a centralized control for various network devices connected to the network.

### BRIEF DESCRIPTION OF DRAWINGS

In the drawings, like reference numbers generally indicate identical, functionally similar, and/or structurally similar elements.

FIG. 1 shows an embodiment of the Smart Media Device (SMD), according to one or more aspects of the present disclosure.

FIG. 2 shows the physical component of an SMD, according to one or more aspects of the present disclosure;

FIG. 3 shows an example of the hardware anatomy of an SMD, according to one or more aspects of the present disclosure;

FIG. 4 shows an example of the software anatomy of an SMD, according to one or more aspects of the present disclosure;

FIG. 5 shows an example of an SMD implementing multiple application programming interfaces (APIs), according to one or more aspects of the present disclosure;

FIG. 6 shows an example of connectivity between an SMD and a third party cloud service, according to one or more aspects of the present disclosure;

FIG. 7 shows an example of connectivity between the SMD and another third party cloud service, according to one or more aspects of the present disclosure;

FIG. 8 shows an alternative to the example shown in FIG. 6, according to one or more aspects of the present disclosure;

FIG. 9 shows an alternative to the example shown in FIG. 7, according to one or more aspects of the present disclosure;

FIG. 10 shows another embodiment of a client device, according to one or more aspects of the present disclosure;

FIG. 11 shows examples of implementation of an SMD in a home, according to one or more aspects of the present disclosure;

FIG. 12 shows an example of placements of one or more SMDs in rooms of the home, according to one or more aspects of the present disclosure;

FIG. 13 shows an example of an SMD menu display, according to one or more aspects of the present disclosure;

FIG. 14 shows an example of one or more functions in one SMD, according to one or more aspects of the present disclosure;

FIG. 15 shows an SMD providing one or more services, according to one or more aspects of the present disclosure;

FIG. 16 shows the SMD connected to one or more network devices, according to one or more aspects of the present disclosure;

FIG. 17 shows an example SMD for providing one or more services, according to one or more aspects of the present disclosure;

FIG. 18 shows examples of services and functions implemented and executed by an SMD, according to one or more aspects of the present disclosure;

FIG. 19 shows a back side of an embodiment of the physical structure of the SMD, according to one or more aspects of the present disclosure;

FIG. 20 shows an embodiment of an SMD, according to one or more aspects of the present disclosure;

FIG. 21 shows another view of the SMD of FIG. 1, according to one or more aspects of the present disclosure;

FIG. 22 shows a back of the SMD of FIGS. 1 and 21, according to one or more aspects of the present disclosure; and

FIG. 23 is a block diagram of circuits of an SMD, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

It should be appreciated that various example embodiments of inventive concepts disclosed herein are not limited to specific numbers or combinations of devices, and there may be one or more multiple of some of the aforementioned network devices in the system, which may itself consist of multiple communication networks and various known or future developed wireless connectivity technologies, protocols, devices, and the like.

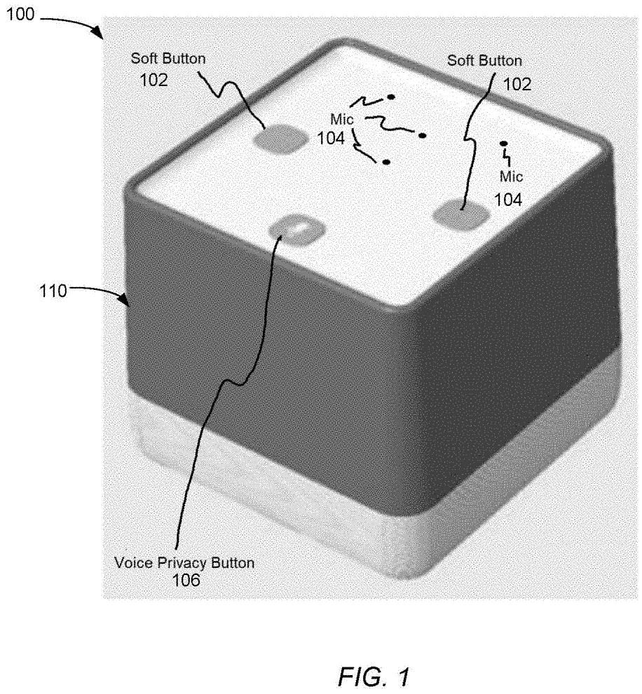

FIG. 1 shows an embodiment of the SMD 100, according to one or more aspects of the present disclosure. The SMD 100 includes an outer surface 110 that encloses one or more components or elements. The SMD includes one or more soft buttons 102. The one or more soft buttons 102 can be programmed to one or more particular functions, such as any of volume up, volume down, tuning, and a menu selection, and any combination thereof according to one or more aspects of the present disclosure. The SMD 100 shown in FIG. 1 includes four small holes 104 below which are respectively positioned on-board microphones. The SMD 100 includes a voice privacy button 106. Voice privacy button 106 can also be a soft button 102 programmed to perform the functionality of voice privacy as discussed herein.

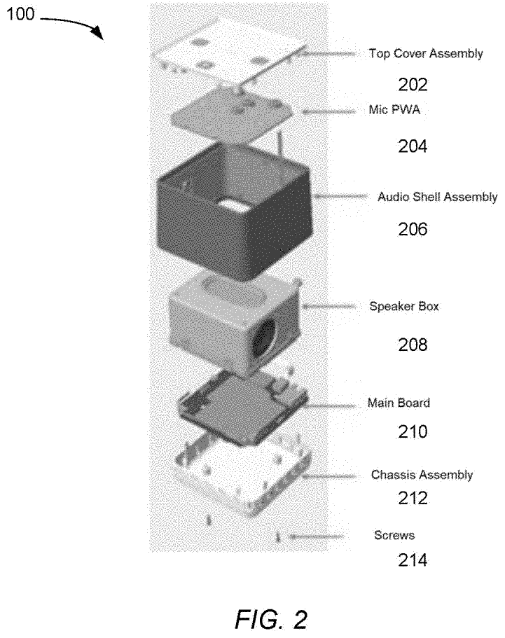

FIG. 2 shows one or more physical components of an embodiment of an SMD 100, according to one or more aspects of the present disclosure. In one or more embodiments, the SMD 100 includes a top cover assembly 202, a microphone printed wiring assembly (PWA) 204, an audio shell assembly 206, a speaker box 208, a main board 210, a chassis assembly 212 and one or more screws 214.

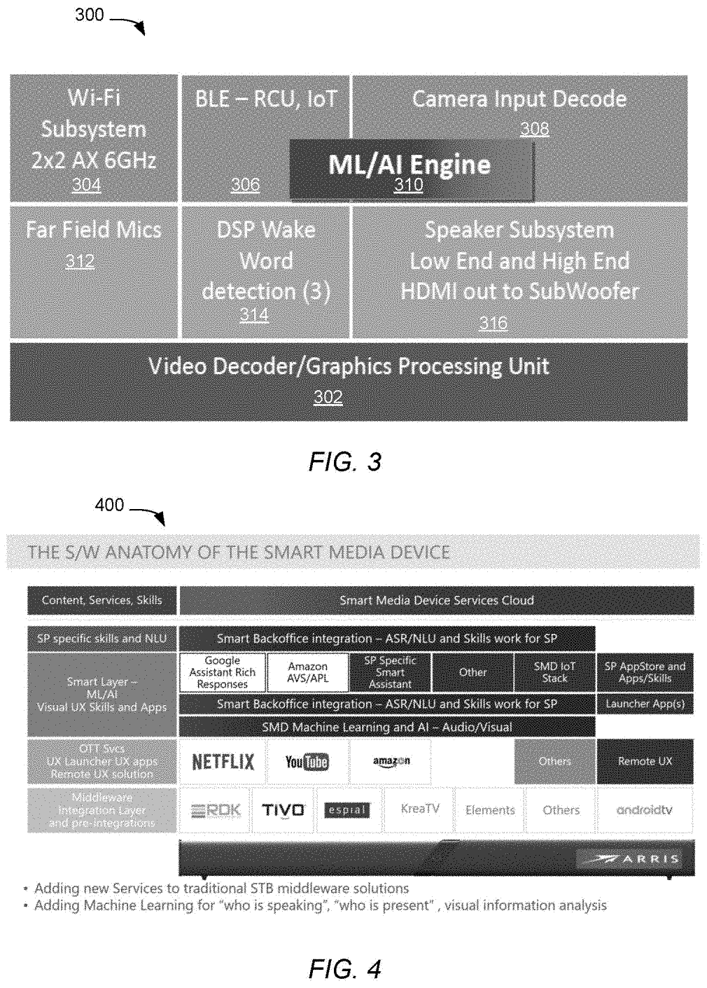

FIG. 3 shows an example of the hardware anatomy 300 of an SMD, for example, SMD 100, according to one or more aspects of the present disclosure. An SMD 100 can include a Machine Learning and Artificial Intelligence (ML/AI) Engine 310, a Wi-Fi subsystem 304, for example, a 2×2 AX 6 GHz 304 or any other Wi-Fi subsystem, a Bluetooth low energy (BLE) remote control (BLE-RCU)/IoT 306, camera input decode 308, one or more far field microphones (mics) 312, a DSP wake word detection 314, a speaker subsystem low end and high end HDMI out to subwoofer 316, and/or a video decoder/graphics processing unit 302.

FIG. 4 shows an example of the software anatomy 400 of an SMD, for example, SMD 100, according to one or more aspects of the present disclosure. FIG. 4 illustrates one or more network services accessible from or controlled by the SMD.

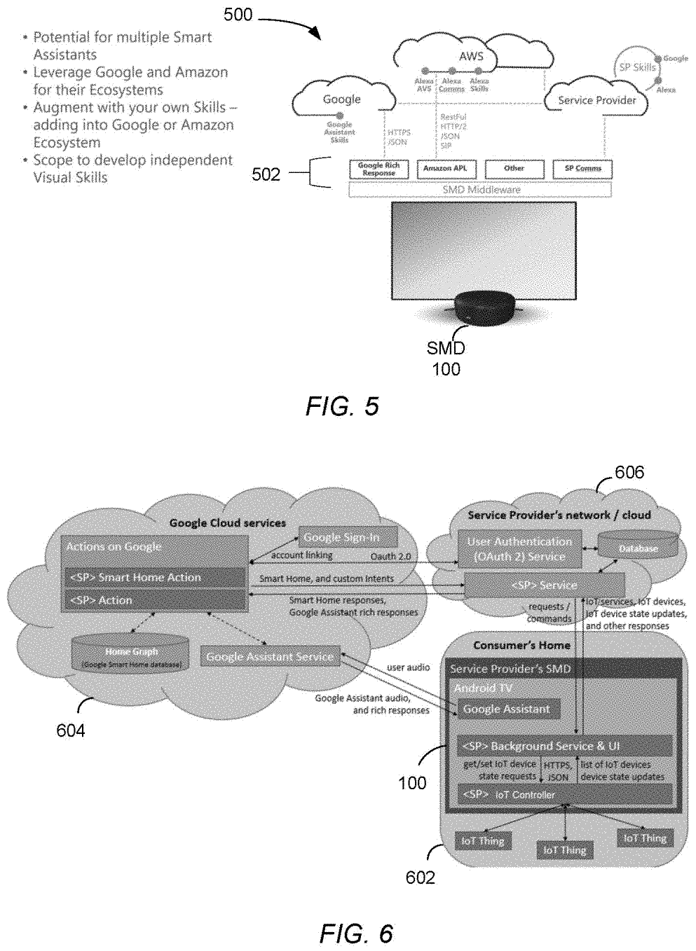

FIG. 5 shows an example of an SMD, for example, SMD 100, implementing multiple application programming interfaces (APIs) 502, according to one or more aspects of the present disclosure.

FIG. 6 shows an example of connectivity between an SMD 100 and a third party cloud service 604, according to one or more aspects of the present disclosure. In one or more embodiments, SMD 100 is at or within a site, such as a consumer's home 602. The SMD 100 can communicate with a service provider's network/cloud storage 606, for example, to receive data or content. The cloud storage 606 can comprise a user authentication service, a database, and one or more services. For example, the SMD 100 can include an IoT controller that is in two-way communications with one or more IoT things. The IoT controller can communicate with a background service and user interface (BSUI). The IoT controller can send a list of IoT devices (IoT things) device state updates to the BSUI and receive a get/set IoT device state request from the BSUI. The SMD 100 can include one or more assistants, for example, a Google Assistant that is in two-way communication with Google cloud services 604. For example, the Google assistant can send received user audio to a Google Assistant Service at the Google Cloud Services 604 and receive Google Assistant audio and rich responses from the Google Assistant service.

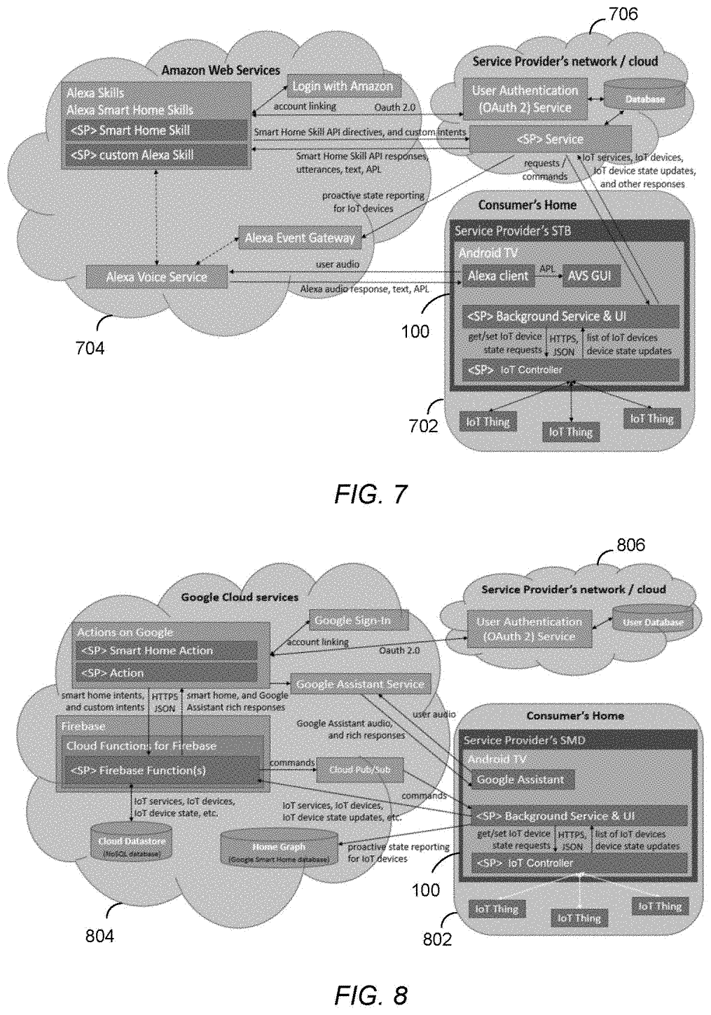

FIG. 7 shows an example of connectivity between an SMD 100 and another third party cloud service 704, according to one or more aspects of the present disclosure. In one or more embodiments, SMD 100 is at or within a site, such as a consumer's home 702. SMD 100 of FIG. 7 is the same as or similar to the SMD 100 of FIG. 6 except that an Alexa client is included instead of a Google Assistant so as to have two-way communications with an Alexa Voice Service (AVS) of an Amazon Web Services (AWS) 704. The Alexa client sends received user audio to the AVS and receives Alexa audio response, text, Alexa presentation language (APL) from the AVS. The service provider's network/cloud storage 706 is similar to or the same as the service provider's network/cloud storage 606 of FIG. 6 except that the service provider's network/cloud 706 is in two-way communication with the AWS 704.

FIG. 8 shows an alternative connectivity between an SMD 100 and another third party cloud service 804 as compared to the example shown in FIG. 6, according to one or more aspects of the present disclosure. In one or more embodiments, SMD 100 is at or within a site, such as a consumer's home 802. SMD 100 of FIG. 8 is the same as or similar to the SMD 100 of FIG. 6 except that the SMD 100 communicates with the Google Cloud Services 804 by providing proactive state reporting for IoT devices to a home graph, providing IoT services, IoT devices, IoT device state updates, etc. to the Firebase, and receiving commands from a cloud pub/sub.

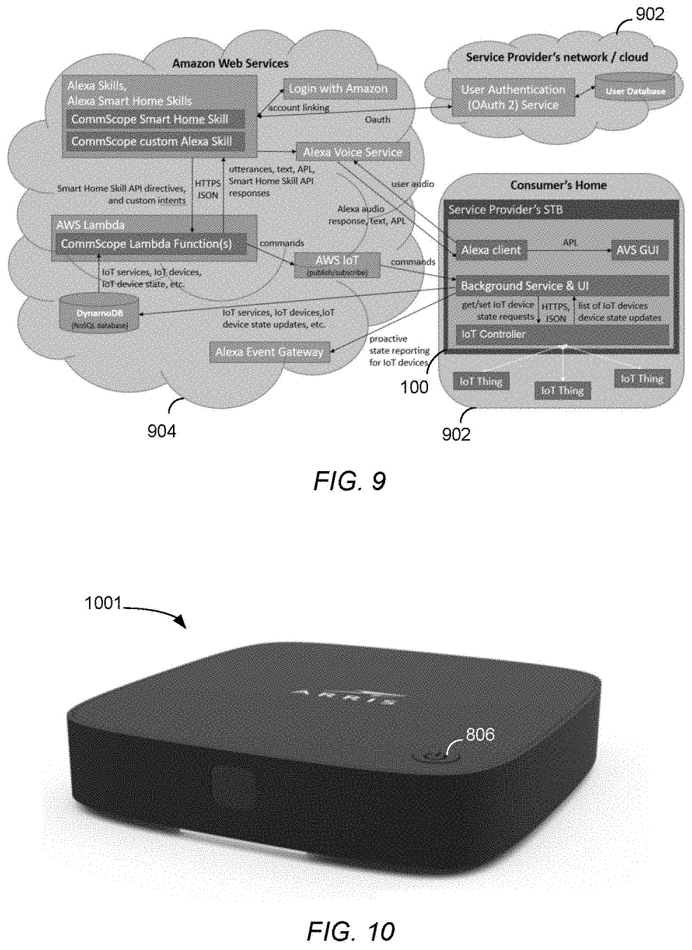

FIG. 9 shows an alternative connectivity between an SMD 100 and another third party cloud service to the example shown in FIG. 7, according to one or more aspects of the present disclosure. In one or more embodiments, SMD 100 is at or within a site, such as a consumer's home 902. The SMD 100 of FIG. 9 is similar to or the same as SMD 100 of FIG. 7 except that the SMD 100 additionally communicates with the AWS 904 by sending proactive state reporting for IoT devices to an Alexa Event Gateway, providing IoT services, IoT devices, IoT device state updates, etc. to a Dynamo database, and receiving one or more commands from an AWS IoT.

FIG. 10 shows an embodiment of the physical structure of a client device 1001, according to one or more aspects of the present disclosure. For example, the client device 1001 includes a soft-button, such as a power-on/power-off button 806. Client device 1001 can interface with and/or connected to the SMD 100.

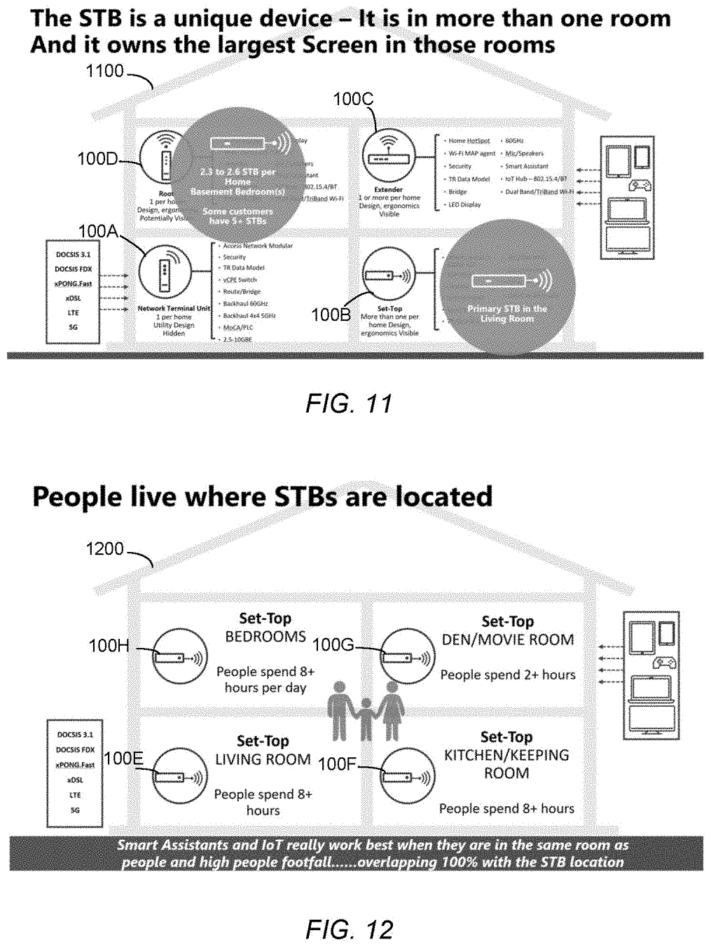

FIG. 11 shows examples of implementation of an SMD 100 in a home 1100, according to one or more aspects of the present disclosure. For example, a home 1100 includes a first SMD 100A, a second SMD 100B, a third SMD 100C, and a fourth SMD 100D located in separate rooms throughout the home 1100. The first SMD 100A can connect to a service provider, for example, service provider 606 of FIGS. 6-9. The second SMD 100B can be a set-top box in a primary location of the home 1100, for example, in a living room. The SMD third 100C can be an extender access point device that, for example, is a hot spot, a Wi-Fi MAP agent, provides security, a TR Data Model, a Bridge, an LED display, or any combination thereof. The third SMD 100C can comprise one or more microphones, one or more speakers, a smart assistant, an IoT hub, a dual band/triband Wi-Fi, or any combination thereof. For example, the third SMD 100C can connect and/or communicate with a tablet, a smartphone, a gaming system, a laptop, a smart TV, a computer, and/or any other network device. The fourth SMD 100D can be a root hub that provides any one or more features as discussed with respect to any of SMDs 100A-100C.

FIG. 12 shows an example of placements of one or more SMDs 100 in one or more rooms of the home 1200, according to one or more aspects of the present disclosure. In one or more embodiments, the home 1200 comprises a first SMD 100E, a second SMD 100F, a third SMD 100G, and a fourth SMD 100F disposed at or about different locations within home 1200. The first SMD 100E can be a set-top box located in a first room of home 1200, for example, a living room. The second SMD 100F can be a set-top box in a second room of the home 1200, for example, a kitchen. The third SMD 100G can be a set-top box in a third room of the home 1200, for example, a den or movie room. The third SMD 100G can connect and/or communicate with a tablet, a smartphone, a gaming system, a laptop, a smart TV, a computer, and/or any other network device. The fourth SMD 100H can be a set-top box in a fourth room of the home 1200, for example, a bedroom.

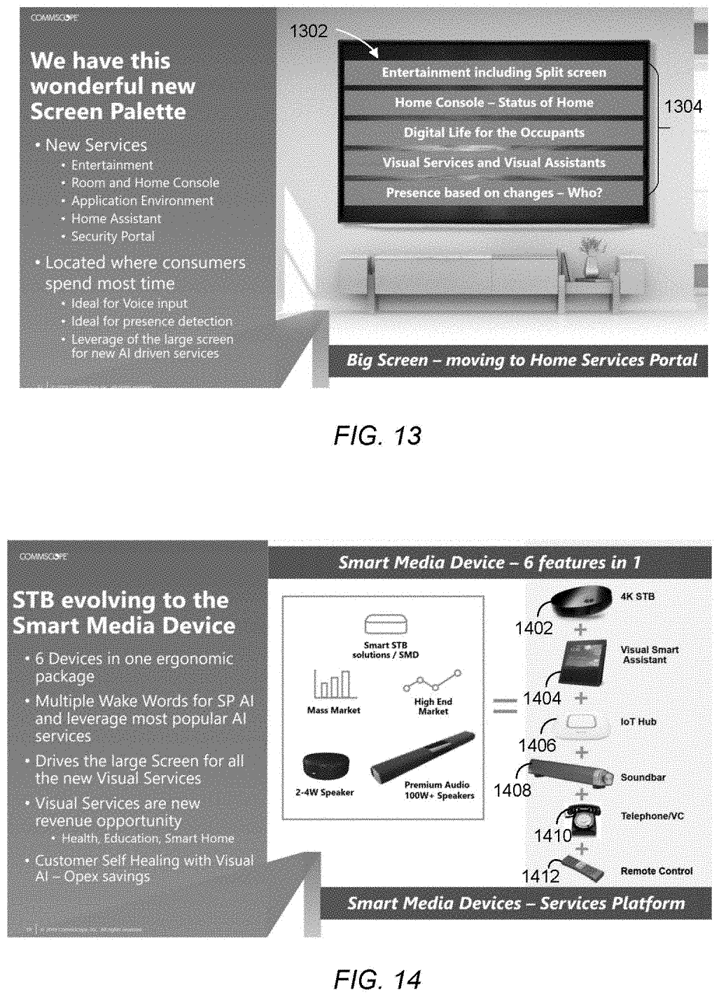

FIG. 13 shows an example of an SMD menu display 1302 associated with an SMD, according to one or more aspects of the present disclosure. For example, one or more menu items 1304 can be associated with one or more services, such as an entertainment service, a room and home console, an application environment, a home assistant, a security portal, etc. In one or more embodiments, the menu items 1304 can be displayed on a television in a room of a home or any other screen in the home. In one or more embodiments, the SMD menu display 1302 can be presented at a display that is in an ideal location for voice input or presence detection or that is positioned for to leverage the large screen for new artificial intelligence (AI) driven services.

FIG. 14 shows an example of one or more functions in an SMD 100, according to one or more aspects of the present disclosure. In one or more embodiments, the one or more functions comprise functions associated with any of 4K set-top box (STB) 1402, a visual smart assistant 1404, an IoT hub 1406, a soundbar 1408, a telephone 1410, a remote control 1412, or any combination thereof.

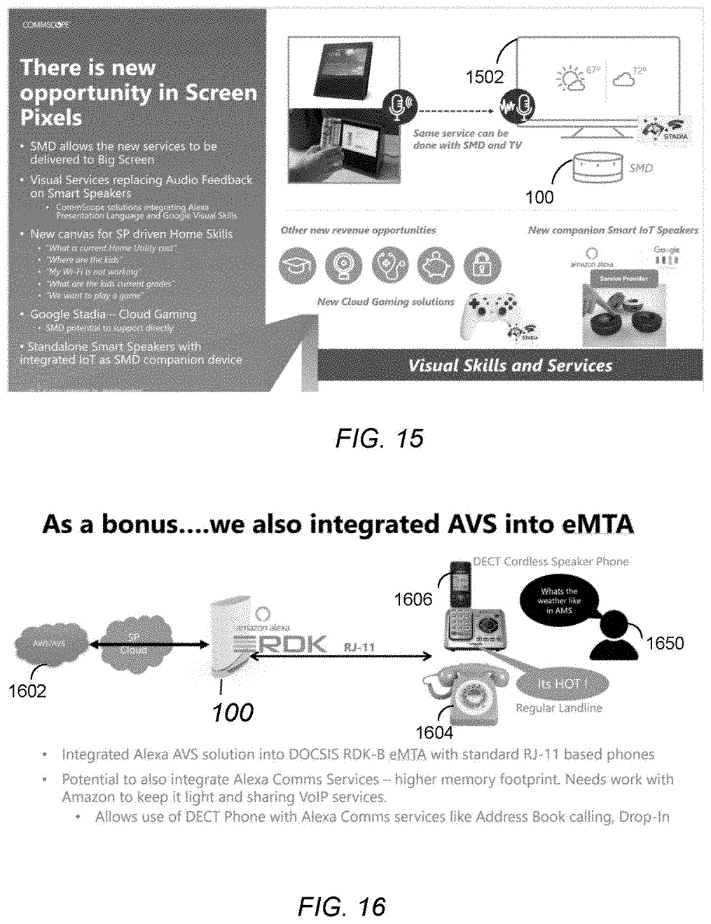

FIG. 15 shows an SMD 100 providing one or more services, according to one or more aspects of the present disclosure. The SMD 100 allows new services to be delivered to larger screens (for example, a television 1502), visual services can replace audio feedback on smart speakers, and standalone smart speakers with integrated IoT as SMD companion devices, according to one or more aspects of the present disclosure.

FIG. 16 shows an SMD 100 connected to one or more network devices, according to one or more aspects of the present disclosure. The SMD 100 can connect with a telephone 1604 and/or a speaker phone 1606, for example, a cordless speaker phone, to communicate information, e.g., via voice over Internet protocol (VoIP), according to one or more aspects of the present disclosure. For example, the SMD 100 can receive one or more voice commands from a user 1650 and send the one or more voice commands to one or more network resources, such as AWS/AVS 1602.

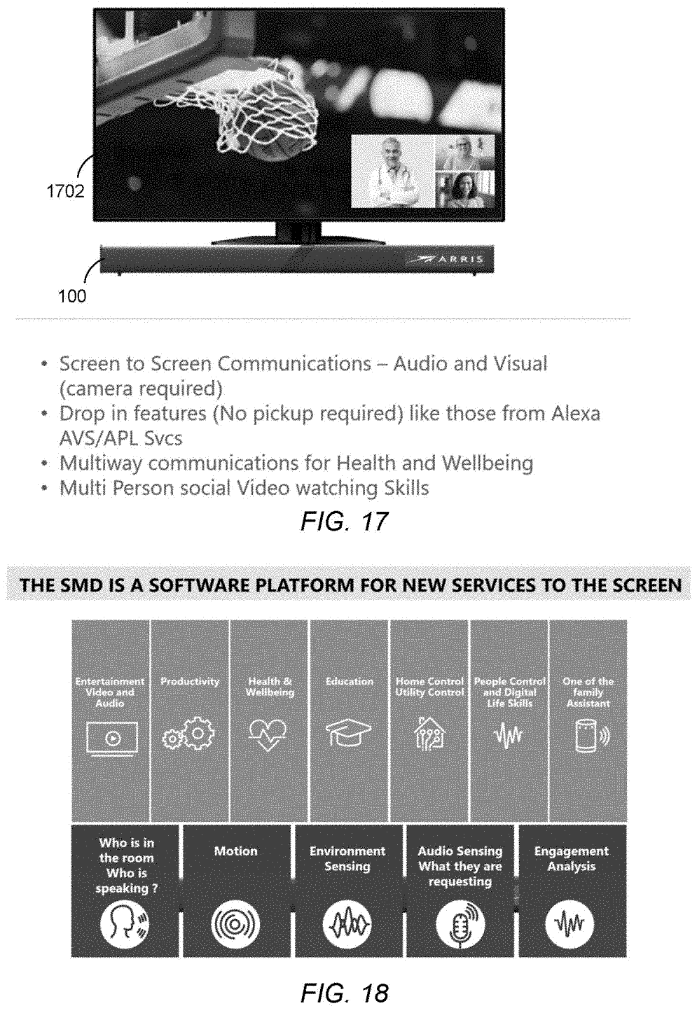

FIG. 17 shows an example SMD 100 for providing one or more services, according to one or more aspects of the present disclosure. In an example implementation, the SMD 100 is connected to a television (TV) 1702 to provide one or more services, such as, screen to screen communication, multiway communications for health and wellbeing, and/or multi-person video watching functions, according to one or more aspects of the present disclosure. The one or more services can include any of screen to screen communications using an audio and visual camera internal to or connected to the SMD 100, a drop in feature such as those from Amazon associated with Alexa (for example, using Alexa Voice Service (AVS)/Alexa Presentation Language (APL) services), multiway communications for health and wellbeing, multi person social video watching skills, or any combination thereof.

FIG. 18 shows examples of services and functions implemented and executed by an SMD, for example, SMD 100, according to one or more aspects of the present disclosure. The one or more services can include entertainment video and audio, productivity, health and wellbeing, education, home control, utility control, people control and digital life skills, and/or one of the family assistant. The one or more services can be triggered or initiated by any of a detection of who is in a proximity or room, who is speaking, a motion detection, an environment sensing, an audio sensing including a request sensing, an engagement analysis, or any combination thereof.

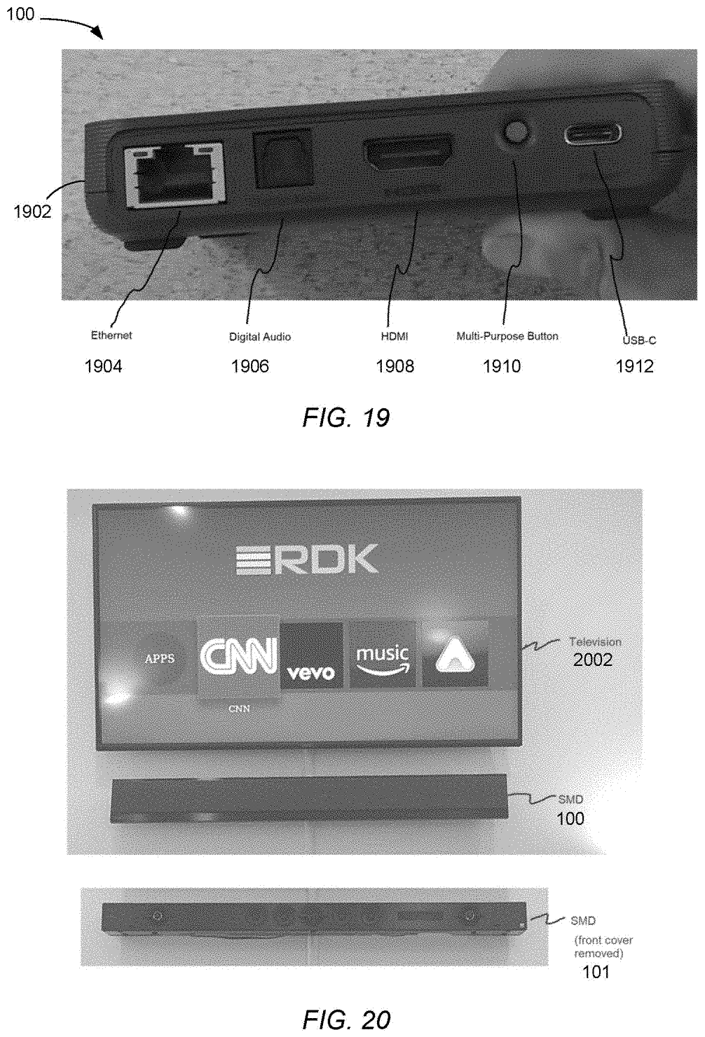

FIG. 19 shows the back side 1902 of an embodiment of the physical structure of an SMD 100, according to one or more aspects of the present disclosure. FIG. 19 shows one or more types of connectors, for example, Ethernet 1904, digital audio (optical) 1906, high-definition multimedia interface (HDMI) 1908, and universal serial bus-C (USB-C) 1912, and a multi-purpose button 1912 (which can be used for Wi-Fi Protected Setup (WPS)).

FIG. 20 shows an embodiment of an SMD 100, for example, in a sound bar form factor (elongated case with speakers on the front). The SMD 100 is located below a television 2002. Below SMD 100 is a view of the SMD 100 with the front face removed as SMD 101. One or more applications can be accessed via the television 2002, for example, CNN, vevo, Amazon music, etc.

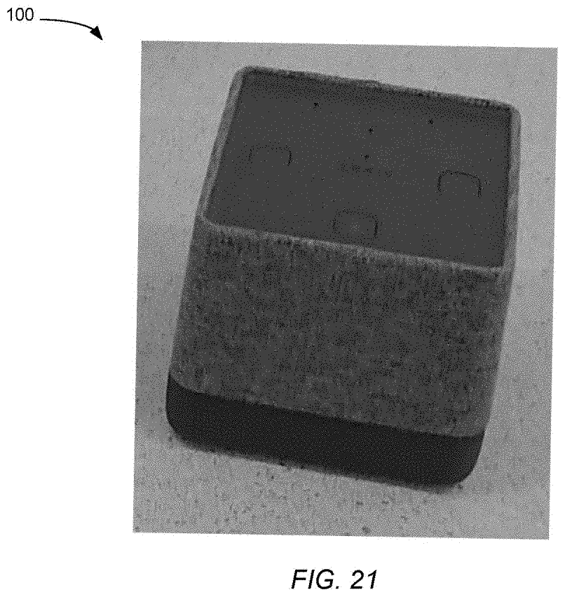

FIG. 21 shows another view of the SMD of FIG. 1, according to one or more aspects of the present disclosure.

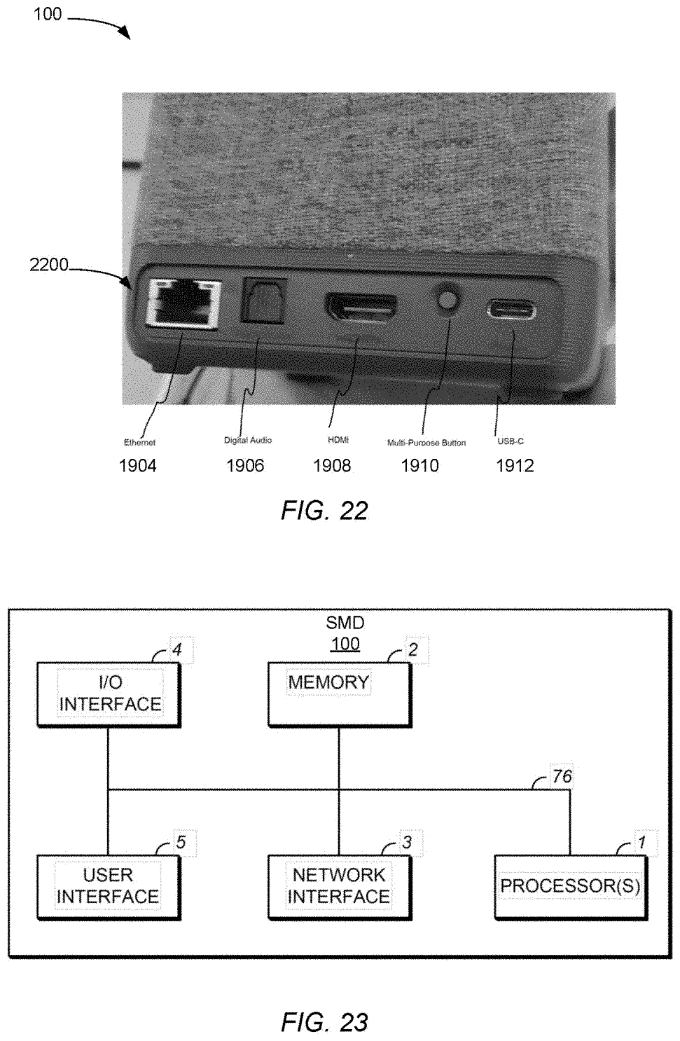

FIG. 22 shows the back 2200 of an SMD 100, for example, of FIGS. 1 and 21, according to one or more aspects of the present disclosure. The back 2200 shows one or more types of connectors, for example, Ethernet 1904, digital audio (optical) 1906, HDMI 1908, USB-C 1910, and a multi-purpose button 1912, such as a reset button.

FIG. 23 is a block diagram of circuits of an SMD 100, according to one or more embodiments of the present disclosure. As illustrated in the block diagram of FIG. 23, an embodiment of the SMD 100, includes one or more processors 1, that execute software programs stored on a memory 2. The SMD 100 includes network interface circuitry 3 that handles external communication, e.g., LAN, Ethernet, cable, or wireless such as 4G, 5G, or 6G communication. The input/output (I/O) interface 4 provides one or more connections, such as HDMI and USB-C, Bluetooth, and/or Wi-Fi, for connection to any of one or more televisions, one or more microphones, one or more smart phones, and one or more IoT devices. The I/O interface 4 can also include additional Wi-Fi bands for Wi-Fi extension functions. The user interface 5 is implemented for allowing communication between a user and the SMD 100. The user interface 5 includes, but is not limited to, any of a mouse, a keyboard, a liquid crystal display (LCD), cathode ray tube (CRT), thin film transistor (TFT), light-emitting diode (LED), high definition (HD), other similar display device with touch screen capabilities, or any combination thereof.

In one or more embodiments, SMD 100 is a smart hub that includes one or more functions. The one or more function can include any of:
(1) An SMD 100 can receive data and content from one or more service providers 602, 702, 802, and/or 902 via wired (e.g., cable) or wireless (e.g., 4G, 5G and beyond) via network interface circuitry 3. For example, content can include any of television programming, health care information, IoT related information, utility information, heating, ventilation, and air conditioning (HVAC) information, etc., or a combination thereof.
(2) An SMD 100 can receive one or more user commands in the form of audio/speech inputs captured via on-board or connected (wired or wireless) microphones, or via one or more devices (that include one or more microphones) which are wirelessly connected to the SMD 100, via, e.g., Wi-Fi, or Bluetooth;
(3) An SMD 100 can receive one or more user commands in the form of one or more user visually indicated commands, in which the “visual skills” of the SMD 100 recognize, via on-board or connected (wired or wireless) camera(s), visual movements of the user representing one or more commands by the user, or representing a condition of the user, such as that the user is falling;
(4) An SMD 100 can output service provider data or content via one or more connected displays/televisions (connected by HDMI, for example), integrated or connected (wired or wireless) speakers/headphones/earbuds;
(5) An SMD 100 can provide two way wireless communications with internet of things (IoT) equipped devices, such as any of one or more appliances, one or more security system components, one or more cameras, one or more health care devices, one or more applications, one or more utility (e.g., HVAC) controls, one or more home lighting controls, using a LAN protocol, such as 802.11ax, or any combination thereof; and
(6) An SMD 100 can provide two way audio and/or audio-video communications with other users.

One or more embodiments of the SMD 100 may integrate IoT features of the various IoT equipped devices and a TV/display by automatically activating an attached TV or display for some IoT features like video security. The IoT equipped device sends information, e.g., thermometer reading, appliance or HVAC settings, lighting status information, etc., to a cloud storage and/or computing system, and such cloud storage sends back to the SMD 100 content which the SMD 100 then displays on the connected TV/display and/or plays audio via connected speakers, for example, as illustrated in FIGS. 5, 15 and 16. The content is specific to the IoT information and could be an indication of the status of the IoT device, an indication that some action is required by the user, a basic diagnosis of a person using the IoT device (a heath care device such as an IoT equipped thermometer), or some communication link to a health care professional, etc. The IoT control can be run on the SMD itself for certain devices without interactions with a cloud server. In this scenario, all IoT control actions stay in the home network. As in the cloud scenario, the TV screen, mics and speakers will be used for User interaction with the IoT devices.

In one or more embodiments, the SMD may be programmed to recognize voice commands and implement controls of IoT devices based on the voice commands, for example, as illustrated in FIG. 15. The voice commands can be commands regarding whether or not to display certain information on the connected TV or display, e.g. to display temperature, show the image captured by a security camera.

The SMD can function as a primary Wi-Fi device (enabling connection of Wi-Fi devices to the internet via Wi-Fi between the connected Wi-Fi device and the service providers connected to the SMD by cable and/or wireless such as 4G, 5G, and/or 6G. The SMD can also function as a Wi-Fi extender by including circuitry implementing two band (2.4/5 MHz) Wi-Fi and triband (including, e.g., 6 Ghz) for backhaul.

As to connectivity, the SMD can be equipped with TV connections (e.g., 4K, and AV1), and suitable connection for HDMI, wireless (Wi-Fi), IPTV or cable (QAM), for example, as illustrated with reference to FIGS. 12 and 22.

The SMD can provide an electronic program guide (EPG) and remote control interface, for example, any audio/visual elements as illustrated in FIG. 4, that is activated by voice command detected via microphone either built into the SMD unit or via a microphone on a hand held remote control of the SMD, or via a microphone on a device wirelessly connected to the SMD, such as a mobile phone connected to the SMD via Bluetooth, etc.

Embodiments of the SMD can execute processing to implement screen casting which moves video display content to another display screen proximate to a user device (e.g., user can be watching a program on an SMD-connected TV and then have the program cast on the user's phone screen). Likewise, video display content from another display screen can be moved to the SMD's display.

A noise cancellation process may be executed by a processor, for example, processor 1 of FIG. 23, in the SMD 100 in order to cancel background noise or TV noise present in the signal input via the microphone and thereby isolate voice commands present in the signal.

Video calls can be implemented with embodiments of the SMD 100 using a remote connected camera or TV camera or integrated camera (if integrated can be shut off with hardware button), and near and/or far field microphones, by executing video call processing by the SMD processor 1.

An SMD 100 can include multiple microphones, either on board (such as illustrated in FIG. 1) or connected, which can be used for beam forming, background noise cancellation, and voice orientation determination.

The SMD 100 can include two built in speakers on opposite sides to effect stereo sound output, for example, a soundbar 1408 of FIG. 14. The audio of the content can be output either to the built in speakers, or to speakers of a connected TV or connected audio system. Further the SMD can detect video is being output via an HDMI port of the SMD 100 and can automatically output the sound to speakers associated with the device connected via the HDMI port, and can also use both the connected TV and the built in speakers to produce a surround-type effect. The SMD can detect if the connected TV is off, and in such case the SMD 100 will use the built in speakers, such as those associated with a speaker box of FIG. 2.

For voice activation, the SMD 100 can run a local voice recognition/voice command system, and can additionally host and execute multiple voice command user interfaces (UIs), such as Google (as illustrated in FIGS. 5, 6 and 8) or Alexa (as illustrated in FIGS. 5, 7 and 9). The SMD 100 can store multiple wake words and provide for association of particular wake words for choosing particular UIs as well as provide for customization of wake words for different UIs, for example, via DSP wake word detection 314 of FIG. 3. The SMD can avoid false positive wake words by noise filtering background noise and TV audio (e.g., eliminate false positive that might occur when audio from content on the TV says a wake work in a commercial, etc.). Note, digital signal processing (DSP) signal processing inverts signals for noise and applies inverted signal to remove background from current audio, leaving user speaking audio detected.

Embodiments of the SMD 100 can include functions of executing application programming interfaces to allow verbal utterance recognition and visual skills functions to accelerate the use of the TV screen for traditional program viewing as well as other services such as health care monitoring and diagnosis, utility management, education, home security, and person to person audio and video communication.

The SMD 100 can be equipped with programming to utilize connected cameras, microphones, or other sensors, and IoT devices to detect the presence of people, whether a person is falling, thermal/IR fluctuations, medical sensing, video chat, and video conferencing and/or one or more services as indicated in FIG. 18.

Rather than being a traditional cable “set top box”, the SMD 100 disclosed herein is a sensory platform for input from and output to the user via cameras, near and far field microphones, displays, IoT equipped devices, and other wireless (e.g., Bluetooth) connected devices.

The SMD 100 can include a voice privacy button 106 of FIG. 1 as hardware, which is not susceptible to software glitches or hacking. The voice privacy button 106 has memory to automatically return to the same position as its last setting even when power is disrupted. The voice privacy button 106 is an electronic persistent switch that does not allow for any software control, meaning once a user places a device in privacy mode the device would remain in that state until the user physically placed the device back into active mode. This state should also be kept through a power outage. The voice privacy button 106 allows for the use of an electronic circuit to perform the toggle and persistence functions, allowing preserving of the state using only a toggle on a voltage and thus allowing for a hardware only solution. The voice privacy button 106 uses a programmable voltage reference as a 1 bit non-volatile memory cell that is programmed by means of a logic pulse to the device, for example, to remember the switch state. This allows a software independent setting of the state of the voice privacy button 106. This state will remain through power cycles. The voltage reference is “programmed” by means of a voltage pulse and requires no software control. A circuit of the voice privacy button sets the state of the switch and toggles the state on each press of the voice privacy button 106.

In one or more embodiments, the present invention includes one or more method embodiments including executing, using at least a processor 1 of an SMD 100, one or more of the following steps including, but not limited to, detecting a wake word or wake gesture via microphone or camera, identifying a smart assistant (SA) based on the wake word or wake gesture, and when provided with multiple SAs use a table of stored wake words related to respective SAs, activating an SA related to the wake word or gesture, communicate a request to the SA, communicate a user set up to the SA, e.g. identification of connected devices (this may be done previously in a set up phase), receive a command from the SA, e.g., as audio only output or audio and video output if connected video, command to provide input from a selected source (e.g., security camera), activate functions for command (e.g., select content or command source/inputs), identify output devices, and output source content or commands to identified devices based on SA commands.

In one or more embodiments, for local only functions, (e.g., TV tuning, set up commands for LAN connections), the present invention includes method embodiments including executing, using at least a processor 1 of an SMD 100, one or more of the following steps including, but not limited to, any of detecting a wake word or wake gesture via microphone or camera, identifying a smart assistant (SA) based on the wake word or wake gesture, and when provided with multiple SAs use a table of stored wake words related to respective SAs, wherein local functions may have their own respective wake words and/or wake gestures, determining if the wake word or wake gesture is for a local function or an SA function, if it is a local function, providing an output command to local devices, (e.g., change channel, select local audio source).

In one or more embodiments, the present invention may be implemented as any combination of a system, a method, an integrated circuit, and a computer program on a non-transitory computer readable recording medium. The circuitry and any other parts of the electronic apparatuses may be implemented as Integrated Circuits (IC), Application-Specific Integrated Circuits (ASIC), or Large Scale Integrated circuits (LSI), system LSI, super LSI, or ultra LSI components which perform a part or all of the functions of the electronic apparatuses, such as set-top boxes.

Each of the parts of the present invention can be implemented using many single-function components, or can be one component integrated using the technologies described above. The circuits may also be implemented as a specifically programmed general purpose processor, central processing unit (CPU), a specialized microprocessor such as Digital Signal Processor that can be directed by program instructions on a memory, a Field Programmable Gate Array (FPGA) that can be programmed after manufacturing, or a reconfigurable processor. Some or all of the functions may be implemented by such a processor 1 of an SMD while some or all of the functions may be implemented by circuitry in any of the forms discussed above.

The present invention may include embodiments including a non-transitory computer-readable recording medium, such as memory 2 of FIG. 23, having recorded thereon a program embodying the methods/algorithms discussed above for instructing the processor(s) to perform the methods/algorithms. The non-transitory computer-readable recording medium 2 can be, for example, a CD-ROM, DVD, Blu-ray disc, or an electronic memory device.

Each of the elements of the present invention may be configured by implementing dedicated hardware or a software program on a memory 2 controlling a processor 1 to perform the functions of any of the components or combinations thereof. Any of the components may be implemented as a CPU or other processor reading and executing a software program from a recording medium such as a hard disk or a semiconductor memory.

The sequence of steps disclosed herein can be considered algorithms for implementation as software by a processor 1 of an SMD 100, such algorithms are exemplary, and algorithms having a sequence other than the above described sequences are contemplated. Moreover, steps, or parts of the algorithm, may be implemented simultaneously or in parallel. The components of the present invention can be in the form of devices as in the exemplary embodiments disclosed above, or in other standalone devices, or may be incorporated in a television or other content playing apparatus, or other device or appliance, and the scope of the present invention is not intended to be limited on such forms. It is also contemplated that the implementation of the components of the present invention can be done with any newly arising technology that may replace any of the above implementation technologies.

The following numbered listing describes, for one non-limiting example of an embodiment of a Smart Media Device 100, an illustrative set of technical requirements.

1. Central Processing Unit (CPU) Technical Requirements

1.1 CPU DMIPS Rating: An embodiment of the device, for example, SMD 100, includes an audio/video (A/V) processor configured to provide a vendor minimum benchmark performance of 24,000 DMIPS (Dhrystone 2.1 or equivalent) core CPU processing capability.

1.2 CPU Thermal Monitoring: An embodiment of the device, for example, SMD 100, is configured to provide the capability to monitor and report the actual temperature of the CPU, for example processor 1.

1.3 CPU Thermal Monitoring: An embodiment of the device, for example, SMD 100, is configured to be based on the BCM72180 CPU.

2. Software Operating System Technical Requirements

2.1 Linux Support: An embodiment of the device, for example, SMD 100, is configured to support executing the Linux O/S on the A/V processor.

3. DRAM Technical Requirements

3.1 2048 MB random access memory (RAM): An embodiment of the device, for example, SMD 100, is configured to provide 2048 MB of DRAM as a factory build option.

3.2 Memory Buffer Content Protection: An embodiment of the device, for example, SMD 100, is configured to provide a means to protect data and/or content that is being buffered in DRAM.

4. FLASH Technical Requirements

4.1 16 gigabyte (GByte) eMMC: An embodiment of the device, for example, SMD 100, is configured to provide a factory build option for 16 GByte of eMMC memory.

4.2 Protected FLASH: An embodiment of the device, for example, SMD 100, is configured to support FLASH memory that can be locked by platform software. An embodiment of the device is configured to provide a fixed size of available FLASH memory as protected memory.

5. Boot Code and Capabilities Technical Requirements

5.1 Remote Control Cold Reset: An embodiment of the device, for example, SMD 100, is configured to provide boot code that provides a means to perform a reset from the remote control, for example, a remote control 1412 of FIG. 14.

5.2 Platform Code Location: An embodiment of the device, for example, SMD 100, is configured to support loading platform software from a network server. An embodiment of the device (SMD 100) is configured to support loading platform software from FLASH. An embodiment of the device (SMD 100) is configured to provide boot code capable of authenticating and executing a platform software image.

6. Conditional Access Cryptography Technical Requirements

An embodiment of the device, for example SMD 100, is configured to support Verimatrix video security as a factory build option.

7. Hardware Security and Robustness Technical Requirements

An embodiment of the device is configured to implement all of the hardware physical security measures necessary to satisfy the Robustness and Compliance Rules.

8. General Cryptography Technical Requirements

8.1 Advanced Encryption Standard (AES) Engine

An embodiment of the device, for example, SMD 100, is configured to provide an AES encrypt/decrypt engine for content security.

8.2 Triple Data Encryption (3DES) Engine

An embodiment of the device, for example, SMD 100, is configured to provide a 3DES encrypt/decrypt engine for content security.

9. Copy Protection Technical Requirements

9.1 high-bandwidth Digital Content Protection (HDCP): An embodiment of the device is configured to support HDCP 1.4 content protection for the HDMI output, for example, HDMI output 1908 of FIG. 19. An embodiment of the device (SMD 100) is configured to support HDCP 2.2 content protection for the HDMI output (HDMO 1908).

9.2 DTCP-IP

An embodiment of the device, for example, SMD 100, is configured to support the use of Digital Transmission Content Protection over Internet Protocol (DTCP-IP) for copy protection of high value content that is transferred over the home network.

10. Home Network Data Bridging and Routing Technical Requirements

10.1 Interface Bridging: An embodiment of the device, for example, SMD 100, is configured to support data bridging between any of its installed home networking interfaces.

10.2 Packet Filtering: An embodiment of the device (SMD 100) is configured to support packet filtering over its home network interfaces.

11. Audio-Video Transport Technical Requirements

11.2 Motion picture experts group-2 (MPEG-2) Transport over IP: An embodiment of the device, for example, SMD 100, is configured to support processing MPEG-2 transport over IP for streams received over the home network interfaces.

11.2 Codec Elementary Stream over real-time transport protocol (RTP): An embodiment of the device (SMD 100) is configured to support processing audio/visual (A/V) elementary streams over RTP for streams received over home network interfaces.

11.3 Home Network Transport: An embodiment of the device (SMD 100) is configured to support the transmission and reception of content over the home network. An embodiment of the device, SMD 100, is configured to provide proportional-integral-derivative (PID) and section filtering for the transport streams over its home network interface. An embodiment of the device (SMD 100) is configured to support processing MPEG-2 transport over adaptive bitrate (ABR) for streams received over the home network interfaces.

11.4 Content Transport from Internal Memory: An embodiment of the device (SMD 100) is configured to support processing A/V content contained in and retrieved from internal FLASH and dynamic random-access memory (DRAM).

11.5 Content Transport from Secure Digital Interface: An embodiment of the device (SMD 100) is configured to support processing A/V content contained in and retrieved from the Secure Digital (SD) interface.

11.6 General Transport Engine Requirements: An embodiment of the device (SDM 100) is configured to support simultaneous processing of at least two (2) MPEG (MPEG-2/MPEG-4) transport streams.

11.7 Content Transport from-to FLASH Memory Interface: An embodiment of the device (SMD 100) is configured to support processing A/V content stored to and retrieved from internal FLASH memory.

12. Video Decoding Technical Requirements

12.1 Simultaneous Video Decodes: An embodiment of the device, for example, SMD 100, is configured to provide one (1) flexible video decoder block capable of one (1) video decode up to 2160P60.

12.2 MPEG2 Decode: The SMD 100, for example, can comprise a Flexible MPEG-2 Video Decoder. An embodiment of the device (SMD 100) is configured to support MPEG-2 (main profile at high level (MP@HL)) video decode.

12.3 MPEG4 Decode: The SMD 100 can comprise a Flexible AVC Video Decoder. An embodiment of the device (SMD 100) is configured to support MPEG-4 Part 10 advanced video coding (AVC) (H.264) high-definition video decode.

12.4 AVC Multiview Video Coding (MVC) Decode Support: An embodiment of the device (SMD 100) is configured to support MPEG-4 Annex H MVC (Multi-view Video Coding) high-definition video decode.

12.5 Flexible VP8 Video Decoder: An embodiment of the device (SDM 100) is configured to support VP8 video decode.

12.6 Flexible VP9 Video Decoder: An embodiment of the device (SDM 100) is configured to support VP9 video decode.

12.7 HEVC Video Decoder: An embodiment of the device (SDM 100) is configured to support high efficiency video coding (HEVC) video decode.

12.8 MPEG Stills Decode: MPEG-2 stills decode. An embodiment of the device (SMD 100) is configured to support MPEG-2 stills decode.

12.9 MPEG-4 AVC stills decode: An embodiment of the device (SMD 100) is configured to support MPEG-4 Part 10 AVC (H.264) video stills decode.

12.10 Video Stills from RAM (Non-Transport Input): An embodiment of the device (SMD 100) is configured to support decoding and displaying MPEG-2 stills from RAM (Non-Transport input) for all MPEG-2 video formats supported by the device for transport stream input. An embodiment of the device (SMD 100) is configured to support decoding and displaying MPEG-4 AVC stills from RAM (Non-Transport input) for all MPEG-4 AVC video formats supported by the device for transport stream input.

12.11 Advanced Video Decode: An embodiment of the device (SMD 100) is configured to support decoding and displaying high dynamic range 10 (HDR10) content. An embodiment of the device (SMD 100) is configured to support decoding and displaying Dolby Vision HDR content as a factory option.

13. Closed Captioning Data Technical Requirements

13.1 Extraction of Closed Caption Data from Digital Services: An embodiment of the device, for example, SMD 100, is configured to support the extraction of MPEG-2 user data. An embodiment of the device (SMD 100) is configured to support the extraction of MPEG-4 AVC user data. An embodiment of the device (SMD 100) is configured to support the extraction of HEVC user data. An embodiment of the device (SMD 100) is configured to be capable of rendering CEA-708C closed captions. An embodiment of the device (SMD 100) is configured to be capable of rendering CEA-608D closed captions.

13.2 FCC Compliance for Closed Captioning: An embodiment of the device (SMD 100) is configured to comply with all FCC Closed Caption requirements as specified in 47cfr15 for CEA-608D and FCC 00-259 for CEA-708C caption information embedded in a Cable TV service.

14. Vertical Blanking Interval (VBI) Data Technical Requirements

14.1 SCTE 127 (formally DVS 706) Support: An embodiment of the device, for example, SMD 100, is configured to support extraction of VBI lines 10-22 from MPEG-2 transport services for the purpose of making the data available to an application.

15. Video Output Resolution Technical Requirements

15.1 Standard Definition Video Generation.

15.2 HDMI Output: An embodiment of the device, for example, SMD 100, is configured to support 480i video resolution on the HDMI output. An embodiment of the device (SMD 100) is configured to support 576i video resolution on the HDMI output.

15.3 Enhanced Definition Video Output Generation: An embodiment of the device (SMD 100) supports HDMI 480p Output. An embodiment of the device is configured to support 480p video resolution on the HDMI output.

15.4 HDMI 576p Output: An embodiment of the device (SMD 100) is configured to support 576p video resolution on the HDMI output.

15.5 High Definition Video Output Generation: An embodiment of the device (SMD 100) includes an HDMI output, for example, HDMI output 1908 of FIG. 19. An embodiment of the device (SMD 100) is configured to support 540p60 video resolution on the HDMI output. An embodiment of the device (SMD 100) is configured to support 720p60 video resolution on the HDMI output. An embodiment of the device (SMD 100) is configured to support 1080i60 video resolution on the HDMI output. An embodiment of the device (SMD 100) is configured to support 1080p24 video resolution on the HDMI output. An embodiment of the device (DMS 100) is configured to support 1080p30 video resolution on the HDMI output. An embodiment of the device (SMD 100) is configured to support 1080p60 video resolution on the HDMI output.

15.6 Ultra-High Definition video output generation: The SMD 100 supports HDMI video output. An embodiment of the device (SMD 100) is configured to support 2160p60 video resolution on the HDMI output. An embodiment of the device (SMD 100) is configured to support 2160p30 video resolution on the HDMI output. An embodiment of the device (SMD 100) is configured to support 2160p24 video resolution on the HDMI output.

16. Video Input Resolution Technical Requirements

16.1 Ultra High Definition Video Input: An embodiment of the device, for example, SMD 100, is configured to support 2160p60 video resolution on the HDMI input.

17. Graphics Engine Technical Requirements

17.1 Graphics Display

17.2 Graphics Overlay—Frame Packed 3DTV Formats: An embodiment of the device, for example, SMD 100, is configured to support graphical overlay on frame-packed 3DTV video output formats.

17.3 Advanced Graphics Functions: Advanced Graphics Functions—Alpha-Blending. An embodiment of the device (SMD 100) is configured to support alpha blending of graphics and video.

17.4 Advanced Graphics Functions—Chroma Keying: An embodiment of the device (SMD 100) is configured to support chroma keying.

17.5 Advanced Graphics Functions—Horizontal and Vertical Scaling: An embodiment of the device (SMD 100) is configured to provide independent horizontal and vertical graphics scaling ranging from 1/32 (downscaling) to 32 (upscaling).

17.6 Advanced Graphics Functions—Anti-Flutter Filtering: An embodiment of the device (SMD 100) is configured to support anti-flutter filtering. An embodiment of the device (SMD 100) is configured to support automatically scaling the graphic surfaces to the selected output video format. An embodiment of the device (SMD 100) is configured to support 4:3 graphic surfaces. An embodiment of the device (SMD 100) is configured to support 16:9 graphic surfaces. An embodiment of the device (SMD 100) is configured to support HD graphics resolutions up to 3840 by 2160 on the primary graphics surface. An embodiment of the device (SDM 100) is configured to support overlaying graphics upon video captured from the HDMI input source. An embodiment of the device (SMD 100) is configured to support the overlaying of SDR format graphics over HDR content on the HDMI output.

17.7 Graphics Acceleration: The device (SMD 100) can support HW 2-D Acceleration Functions. An embodiment of the device (SMD 100) is configured to provide 2D graphics acceleration.

17.8 HW 3-D Graphics Acceleration: An embodiment of the device (SMD 100) is configured to provide 3D graphics acceleration.

17.9. Graphics Performance: An embodiment of the device (SMD 100) is configured to support HD graphics at a frame rate up to 100 Mpixels/second while not decoding video.

18. Video Formatting and Control Technical Requirements

18.1. Video Conversion Processing on HDMI Output

18.2. Video Conversion to 2160p60 on HDMI: An embodiment of the device (SMD 100) is configured to be capable of converting any supported video decode format to 2160p60 video resolution on the HDMI output.

18.3. Video Conversion to 2160p30 on HDMI: An embodiment of the device (SMD 100) is configured to be capable of converting any supported video decode format to 2160p30 video resolution on the HDMI output.

18.4. Video Conversion to 2160p24 on HDMI: An embodiment of the device (SMD 100) is configured to be capable of converting any supported video decode format to 2160p24 video resolution on the HDMI output.

18.5. Video Conversion to 1080p60 on HDMI: An embodiment of the device (SMD 100) is configured to be capable of converting any supported video decode format to 1080p60 video resolution on the HDMI output.

18.6. Video Conversion to 1080p30 on HDMI: An embodiment of the device (SMD 100) is configured to be capable of converting 1080p30 video decode format to 1080p30 video resolution on the HDMI output.

18.7. Video Conversion to 1080p24 on HDMI: An embodiment of the device (SMD 100) is configured to be capable of converting 1080p24 video decode format to 1080p24 video resolution on the HDMI output.

18.8. Video Conversion to 1080i on HDMI: An embodiment of the device (SMD 100) is configured to be capable of converting any supported video decode format to 1080i video resolution on the HDMI output.

18.9. Video Conversion to 720p on HDMI: An embodiment of the device (SMD 100) is configured to be capable of converting any supported video decode format to 720p video resolution on the HDMI output.

18.10. Video Conversion to 576p on HDMI: An embodiment of the device (SMD 100) is configured to be capable of converting any native 25 fps supported video decode format to 576p video resolution on the HDMI output. An embodiment of the device (SMD 100) is configured to be capable of converting any native 50 fps supported video decode format to 576p video resolution on the HDMI output.

18.11. Video Conversion to 576i on HDMI: An embodiment of the device (SMD 100) is configured to be capable of converting any native 25 fps supported video decode format to 576i video resolution on the HDMI output. An embodiment of the device (SMD 100) is configured to support converting any native 50 fps supported video decode format to 576i video resolution on the HDMI output.

18.12. Video Conversion to 480p on HDMI: An embodiment of the device (SMD 100) is configured to be capable of converting any supported video decode format to 480p video resolution on the HDMI output.

18.13. Video Conversion to 480i on HDMI: An embodiment of the device (SMD 100) is configured to be capable of converting any supported video decode format to 480i video resolution on the HDMI output.

18.14. Video Conversion: An embodiment of the device (SMD 100) is configured to support converting BT.2020 colorspace for UHD content to BT.709 colorspace. An embodiment of the device (SMD 100) is configured to support converting between 4:3 and 16:9 aspect ratios.

18.15. Advanced Video Processing: Motion Adaptive De-Interlacing: An embodiment of the device (SMD 100) is configured to support motion-adaptive de-interlacing.

18.16. Spatio-temporal De-Interlacing: An embodiment of the device (SMD 100) is configured to support spatio-temporal de-interlacing.

18.17. Video Noise Filtering: An embodiment of the device (SMD 100) is configured to support digital video noise filtering.

18.18. Video Sharpness Settings: An embodiment of the device (SMD 100) is configured to support software controllable video output sharpness.

18.19. Analog Video Noise Reduction: An embodiment of the device (SMD 100) is configured to support gaussian video noise reduction.

18.20. Cadence And 3-2 Pulldown: An embodiment of the device (SMD 100) is configured to support 3:2 pull-down video sequence detection and filtering.

18.21. Post Processing Enhancements: An embodiment of the device (SMD 100) is configured to support software controllable video post-processing enhancements.

18.22. Picture-In-Graphics: An embodiment of the device (SMD 100) is configured to support Picture in Graphics functionality. An embodiment of the device (SMD 100) is configured to support scaling video in a minimum of 1/32 increments for Picture in Graphics.

18.23. Stretch and Zoom Control: An embodiment of the device (SMD 100) is configured to support video stretch control. An embodiment of the device (SMD 100) is configured to support video zoom control.

18.24. Selectable Border Colors: An embodiment of the device (SMD 100) is configured to support selectable black and gray video border colors.

19. Still Image Decoding Technical Requirements

19.1. JPEG Still Images: An embodiment of the device, for example, SMD 100, is configured to support hardware decode of JPEG still images.

19.2. GIF Still Images: An embodiment of the device (SMD 100) is configured to support hardware decode of GIF still images.

19.3. PNG Still Images: An embodiment of the device (SMD 100) is configured to support hardware decode of PNG still images.

20. Audio Decoding Technical Requirements

20.1. Simultaneous Audio Decodes: An embodiment of the device (SMD 100) is configured to support two (2) simultaneous independent audio decodes.

20.2. Linear Pulse Code Modulation (LPCM) Decode: An embodiment of the device (SMD 100) is configured to support LPCM audio input (uncompressed audio) for audio processing and output.

20.3. Non-Linear Pulse Code Modulation (LPCM) Decode: An embodiment of the device (SMD 100) is configured to support non-linear PCM audio input (uncompressed audio) for audio processing and output.

20.4. Low Complexity Subband Coding (SBC): An embodiment of the device (SMD 100) is configured to support SBC audio input for audio processing and output.

20.5. MPEG-1 Layer 2 Decode: An embodiment of the device (SMD 100) is configured to support MPEG-1 Layer 2 audio decode.

20.6. MPEG-1,2 Layer 3 (MP3) Decode: An embodiment of the device (SMD 100) is configured to support MPEG-1,2 Layer 3 (MP3) audio decode.

20.7. MPEG-2, 4 AAC-LC Decode (AAC Low Complexity): An embodiment of the device (SMD 100) is configured to support MPEG-2,4 AAC-LC audio decode.

20.8. MPEG-4 HE-AAC Decode (High Efficiency AAC vi): An embodiment of the device (SMD 100) is configured to support MPEG-4 HE AAC (AAC+) audio decode.

20.9. MPEG-4 HE-AAC v2 Decode (High Efficiency AAC v2): An embodiment of the device (SMD 100) is configured to support Dolby Pulse (AAC) audio decode.

20.10. Dolby Digital Decode: An embodiment of the device (SMD 100) is configured to support Dolby Digital audio decode.

20.11. Dolby Digital Plus Decode: An embodiment of the device (SMD 100) is configured to support Dolby Digital Plus audio decode.

20.12. Dolby Atmos Pass-through: An embodiment of the device (SMD 100) is configured to support Dolby Atmos pass-through.

20.13. Dolby AC-4: An embodiment of the device (SMD 100) is configured to support Dolby AC-4 audio decode.

21. Audio Formatting and Control Technical Requirements

21.1. Audio DSP Support: An embodiment of the device, for example, SMD 100, is configured to provide an audio DSP that supports Dolby Labs MS12 Configuration B implementation

21.2. Dolby DAPv2: An embodiment of the device (SMD 100) is configured to support Dolby DAPv2 Content Processing features; dialog enhancer, volume leveler (aka Dolby volume) and intelligent equalizer. (Note: Content Processing is a bundling including all 3 features)

21.3. Digital Audio Compression: Dolby Digital: An embodiment of the device (SMD 100) is configured to support audio dynamic range compression adjustment for Dolby Digital for the RF and/or line audio output(s).

21.4. Dolby Digital Plus: An embodiment of the device (SMD 100) is configured to support audio dynamic range compression adjustment for Dolby Digital Plus for the RF and/or line audio output(s).

21.5. Digital Audio Mixing Capability: An embodiment of the device (SMD 100) is configured to support a multi-channel audio mixing capability, blending the primary decoded audio with a secondary uncompressed multi-channel audio source. An embodiment of the device (SMD 100) is configured to support receiver mixed supplementary audio.

21.6. Audio Downmixing and Mapping: An embodiment of the device (SMD 100) is configured to be capable of mapping single/multichannel audio input streams to stereo/multichannel audio output streams to support external audio playback devices. An embodiment of the device (SMD 100) is configured to be capable of downmixing all multichannel audio codecs supported by the device (SMD 100).

21.7. Audio Processing for Wireless Streaming: An embodiment of the device (SMD 100) is configured to be capable of selecting and processing audio from either program in a multi-program decode for Bluetooth encoding.

21.8. Simultaneous Baseband and Digital Audio Output Support: An embodiment of the device (SMD 100) is configured to support simultaneous audio output on all baseband and digital audio outputs.

22. Local Storage Technical Requirements

22.1. External Secure Digital Slot: An embodiment of the device (SMD 100) is configured to provide an external micro secure digital (mSD) card slot on the rear panel as a factory build option.

22.2. Internal eMMC (PLTV): An embodiment of the device (SMD 100) is configured to be capable of partitioning the eMMC for local TSB storage. Note: The TSB will be for Pause Live TV (PLTV) and not recording—long term storage.

23. Local Digital Video Recorder (DVR) Technical Requirements

23.1. Simultaneous Session Limits FLASH Memory Interface: An embodiment of the device (SMD 100) is configured to support streaming up to one (1) UHD streams to the FLASH memory interface. Note: The FLASH memory DVR resource is limited to Trick Play of Foreground/Live TV content only. The FLASH memory DVR resource is not required to Record or Playback content.

24. Multi-Room Digital Video Recorder (DVR) Technical Requirements

24.1. Networked DVR Playback Features: The device (SMD 100) can support one or more networked DVR playback features.

24.2. Network Playback Support from 1 Client: An embodiment of the device, for example, SMD 100, is configured to support playing back (1) HD or SD stream from a Network DVR compatible device.

25. Physical Audio Input Connection Technical Requirements

25.1. HDMI Audio Input: The device, for example, SMD 100, supports HDMI audio input.

25.2. Audio Format Support: An embodiment of the device (SMD 100) is configured to support 2-channel SBC audio from the Bluetooth interface.

26. Physical Video Output Connection Technical Requirements

26.1. HDMI Video Output: An embodiment of the device, for example, SMD 100, support HDMI video output.

26.2. Physical Connector: An embodiment of the device (SMD 100) is configured to provide (1) HDMI video/audio output on the rear panel, for example via HDMI 1908 of FIG. 19.

26.3. Certification: An embodiment of the device (SMD 100) is configured to be certified for HDMI.

26.4. Selectable Output Control and Hot Plug Detection: An embodiment of the device (SMD 100) is configured to be capable of disabling the HDMI output independent of any other output under software control. An embodiment of the device (SMD 100) is configured to be capable of disabling the HDMI output under software control.

26.5. Frame Compatible (Half Resolution) 3DTV Video Format Support: An embodiment of the device (SMD 100) is configured to support frame compatible (half resolution) 3DTV video on the HDMI output.

26.6. Frame Packed (Full Resolution) 3DTV Video Format Support: An embodiment of the device (SMD 100) is configured to support frame packed (full resolution) 3DTV video on the HDMI output.

26.7. HDMI CEC Support: An embodiment of the device (SMD 100) is configured to support HDMI CEC for the HDMI output.

26.8. HDMI I2C Fast Transfer Mode: An embodiment of the device (SMD 100) is configured to support 400 kHz fast transfer mode on the HDMI output.

26.9. Video Certification: An embodiment of the device (SMD 100) is configured to be certified for Dolby Vision VS10.

27. Physical Audio Output Connection Technical Requirements

27.1. HDMI Audio Output: The device, for example, SMD 100, support HDMI audio output.

27.2. Adjustable Audio Delay: An embodiment of the device (SMD 100) is configured to support independent audio delay adjustment over the HDMI interface under software control.

27.3. Audio Format Support: An embodiment of the device (SMD 100) is configured to support 2-channel PCM audio output over the HDMI interface for any supported audio input format. An embodiment of the device (SMD 100) is configured to support Dolby Digital audio output over the HDMI interface. An embodiment of the device (SMD 100) is configured to support Dolby Digital Plus audio output over the HDMI interface.

27.4. Digital Audio Out S-PDIF Optical (Toslink): Digital Audio Out S-PDIF Optical (General): An embodiment of the device (SMD 100) is configured to provide (1) Optical S/PDIF output on the rear panel as a factory build option.

27.5. Digital Audio Out S-PDIF Optical Control: An embodiment of the device (SMD 100) is configured to be capable of disabling the Digital Audio S/PDIF Optical output independently of any other output under software control.

27.6. Audio Certifications: An embodiment of the device (SMD 100) is configured to satisfy the Dolby Multistream Decoder Version 12 (Dolby MS12) with DAP v2 audio processing certification requirements.

28. Wired Data Networking Connection Technical Requirements

28.1. Universal Serial Bus (USB): The device, for example, SMD 100, can include a USB, for example, a USV-C 1912 of FIG. 22.

28.2. Installed Ports (Front-Rear): An embodiment of the device (SMD 100) is configured to provide one (1) USB-C interface on the rear panel.

28.3. Test Ports: An embodiment of the device (SMD 100) is configured to provide one (1) internal serial interface to serve as a test port.

29. Wireless Data Networking Connection Technical Requirements

29.1. Wireless 802.11: The device, for example, SMD 100, supports Wireless 802.11.

29.2. General Wi-Fi Requirements: An embodiment of the device (SMD 100) is configured to provide two (2) internal 802.11 b/g/n/ac/ax 2×2 wireless networking interfaces to support 2.4/5 GHz dual band selectable operation.

29.3. Internal and External Antenna Requirements: An embodiment of the device (SMD 100) is configured to provide at least two (2) dual-band antennas integrated within the device enclosure.

29.4. Wi-Fi Performance Requirements: An embodiment of the device (SMD 100) is configured to support the Wi-Fi Dynamic Frequency Selection (DFS) mechanism. An embodiment of the device (SMD 100) is configured to support the Wi-Fi Radio Resource Management.

29.5. Wi-Fi Security and Encryption: An embodiment of the device (SMD 100) is configured to be capable of supporting WEP, WPA, and WPA2 encryption. An embodiment of the device (SMD 100) is configured to provide a Wi-Fi Protected Setup (WPS) mechanism, including pin method and push button method.

29.6. Wi-Fi Certifications: An embodiment of the device (SMD 100) is configured to be capable of being Wi-Fi 802.11b/g/n certified. An embodiment of the device (SMD 100) is configured to be capable of being Wi-Fi 802.11ac certified. An embodiment of the device (SMD 100) is configured to be capable of being Wi-Fi 802.11ax certified.

29.7. Bluetooth Interface: Optional Internal Bluetooth Transceiver: An embodiment of the device (SMD 100) is configured to provide a Bluetooth v5.0 with LE (Low Energy) support.

29.8. Infrared (IR) Input Interface: IR Input (Qty 1—Front panel): An embodiment of the device (SMD 100) is configured to provide one (1) IR receiver on the front panel.

29.9. IR Input (GI Keycode Set): An embodiment of the device (SMD 100) is configured to support the GI keycode set for the IR receiver as an order option.

29.10. Wireless Interfaces Interoperability: An embodiment of the device (SMD 100) is configured to support concurrent operations of multiple wireless interfaces without any adverse interference.

30. Front and Top Panel Technical Requirements

30.1. Front-Top Panel Buttons: The device, for example, SMD 100, can include one or more front-top panel buttons, such as one or more soft buttons 102 of FIG. 1.

30.2. Voice Privacy Button: An embodiment of the device (SMD 100) is configured to provide a voice privacy button, for example, voice privacy button 106 of FIG. 1, on the top panel.

30.3. Standalone LED Indicators: ‘General Status’ LED Indicator: An embodiment of the device (SMD 100) is configured to provide (1) General Status indicator on the front panel.

31. Rear and Bottom Panel Technical Requirements

31.1. Mechanical Switch: An embodiment of the device, for example, SMD 100, is configured to provide a mechanical switch on the rear panel. Note: The usage of this button may be multi-purpose.

32. Reliability and Failure Rate Technical Requirements

32.1. Mean Time Between Failure: An embodiment of the device, for example, SMD 100, is designed for a mean time between failure (MTBF)≥100,000 hours at the maximum specified operating temperature (+40° C.). An embodiment of the device (SMD 100) is designed for a mean time between failure (MTBF) of ≥438,000 hours at the nominal specified operating temperature (+25° C.).

33. Internal Power Management Technical Requirements

33.1. ‘Wake On’ Support: An embodiment of the device (SMD 100) is configured to support “Wake On LAN” functionality on its Ethernet connection. An embodiment of the device (SMD 100) is configured to support “Wake On IR” functionality on its IR interface. An embodiment of the device (SMD 100) is configured to support “Wake On Bluetooth” functionality via its Bluetooth remote control interface. An embodiment of the device (SMD 100) is configured to support a sleep mode of operation which reduces power consumption of the device. An embodiment of the device (SMD 100) is configured to support the ability to power down internal subsystems and interfaces, under the control of software, to achieve required power savings. An embodiment of the device (SMD 100) is configured to support power optimizations during active modes of operation which reduces power consumption of the device.

34. Device Enclosure Technical Requirements

34.1. Weight and Dimensions: An embodiment of the device, for example, SMD 100, is designed to have physical dimensions and weight in accordance with a horizontally oriented headed video client.

34.2. Environmental Operating Requirements: An embodiment of the device (SMD 100) is designed for acceptable performance over nominal ranges of ambient temperature and humidity.

34.3. Environmental Storage Requirements: An embodiment of the device (SMD 100) is designed for acceptable performance after storage over nominal and extreme ranges of ambient temperature and humidity.

34.4. RF Susceptibility & Emissions Requirements: An embodiment of the device (SMD 100) is designed for acceptable performance over nominal ranges of RF interference.

34.5. Electrostatic Discharge Requirements: An embodiment of the device (SMD 100) is designed for acceptable performance over nominal ranges of electrostatic discharge.

34.6. Altitude Requirements: An embodiment of the device (SMD 100) is designed for acceptable performance over nominal ranges of operational altitude. An embodiment of the device (SMD 100) is designed for acceptable performance after storage over nominal and extreme ranges of altitude.

34.7. Static Load Requirements: An embodiment of the device (SMD 100) is designed for acceptable performance during exposure to nominal ranges of static load.

34.8. Button Load Requirements: An embodiment of the device (SMD 100) is designed for acceptable button performance over its operational lifetime.

34.9. General Chassis Requirements: An embodiment of the device (SMD 100) is designed with chassis and top cover characteristics suitable for household installations. An embodiment of the device (SMD 100) is configured to be resistant to tampering and opening the enclosure by the customer.

34.10. Cooling Requirements: Acoustic Requirements: An embodiment of the device (SMD 100) is designed to at least match the acoustic performance of other living room oriented consumer electronics products. An embodiment of the device (SMD 100) is configured to be passively cooled.

34.11. Lightning Immunity Requirements: An embodiment of the device (SMD 100) is designed for acceptable operational and non-operational performance during exposure to nominal and extreme ranges of lightning surge.

34.12. Mechanical Shock and Vibration Resistance Requirements: An embodiment of the device (SMD 100) is designed for acceptable performance after exposure to nominal and extreme levels of mechanical shock and vibration during shipping and operation.

34.13. Removable Secure Digital (SD) Card: An embodiment of the device (SMD 100) is configured to provide a rear panel access for removal/installation of the secure digital (SD) card slot.

35. Factory Provisioning Technical Requirements

35.1. MAC Address Provisioning: The device, for example, SMD 100, supports MAC address provisioning.

35.2. Ethernet MAC Address: An embodiment of the device (SMD 100) is configured to be provisioned with a MAC address for Ethernet at the factory.

35.3. IEEE-802.11 Wi-Fi MAC Address: An embodiment of the device (SMD 100) is configured to be provisioned with a MAC address for Wi-Fi (if installed) at the factory.

35.4. Set-top Box (STB) MAC Address: An embodiment of the device (SMD 100) is configured to be provisioned with a STB MAC address at the factory.

35.5. Bluetooth MAC Address: An embodiment of the device (SMD 100) is configured to be provisioned with a MAC address for Bluetooth (if installed) at the factory.

35.6. Serial Number: An embodiment of the device (SMD 100) is configured to be provisioned with an embedded serial number at the factory.

35.7. Public-Private Certificates and Keys: An embodiment of the device (SMD 100) is configured to include an RSA public key permanently pre-configured in read-only memory (ROM).

35.8. Certificates and Keys: An embodiment of the device (SMD 100) is configured to be provisioned with a Code Signature public key at the factory.

35.9. HDCP Certificates and Keys: An embodiment of the device (SMD 100) is configured to be provisioned with an HDCP transmitter key at the factory.

35.10. DTCP and DTCP-IP Certificates and Keys: An embodiment of the device (SMD 100) is configured to be provisioned with a DTCP-IP certificate and keys at the factory.

35.11. Generic Device Certificates and Keys: An embodiment of the device (SMD 100) is configured to be provisioned with a Generic certificate and keys (i.e. Secure RSA data) at the factory.

35.12. Microsoft PlayReady: An embodiment of the device (SMD 100) is configured to be provisioned with Microsoft PlayReady certificate and keys at the factory.

35.13. Agilus Certificates and Keys: An embodiment of the device (SMD 100) is configured to be provisioned with Agilus Certificates and keys at the factory.

35.14. Widevine Keys: An embodiment of the device (SMD 100) is configured to include Widevine KeyBoxes for BRCM Sage permanently pre-configured in read-only memory (ROM).

35.15. Platform Code: An embodiment of the device (SMD 100) is configured to be provisioned with a fully operational software image at the factory.

36. Sensors and Speakers

36.1. External Sensors: An embodiment of the device (SMD 100) is configured to provide an independent temperature sensor readable by the CPU software.

36.2. Speakers: An embodiment of the device (SMD 100) is configured to have (2) two speakers with stereo audio (L/R) output. An embodiment of the device (SMD 100) is configured to include a passive radiator.

37. Acoustic Audio Input: An embodiment of the device (SMD 100) is configured to include a voice DSP with wake-word and mic input support.

While certain method steps are presented in a certain order, the present disclosure contemplates that any one or more steps can be performed simultaneously, substantially simultaneously, repeatedly, in any order or not at all (omitted).

In one or more aspects of the present disclosure, a smart media device (SMD) comprises a memory for controlling, interacting with, using, and experiencing services provide by one or more service providers. The SMD is a smart hub for:
(1) data and content flowing in from the service providers via wired (e.g., Cable, xDSL, Satellite, OTA Antenna, etc.) or wireless (e.g., 4G, CBRS, 5G and beyond), where content can include, e.g., television programming, health care information, IoT related information, gaming, utility information, HVAC information etc.;
(2) one or more user commands in the form of audio/speech inputs captured via on-board or connected (wired or wireless) microphones (for example, one or more microphones 104 of FIG. 1), or via devices (that include microphones) which are wirelessly connected to the SMD, via, e.g., Wi-Fi, or Bluetooth;
(3) one or more user commands in the form of user visually indicated commands, in which the “visual skills” of the SMD recognize, via on-board or connected (wired or wireless) camera(s), visual movements of the user representing commands by the user, for example, as illustrated in FIG. 18;
(4) output of service provider content via connected displays/televisions, integrated or connected (wired or wireless) speakers/headphones/earbuds;
(5) two way communications with internet of things (IoT) equipped devices, such as appliances, security system components and cameras, health care devices, applications, utility (e.g., HVAC) controls, and home lighting controls, using a LAN protocol, such as 802.11ax; and
(6) two way audio and/or audio-video communications with other users.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A smart media device (SMD), the SMD comprising:
a network interface;
a microphone;
a camera;
a display;
a memory storing one or more computer-readable instructions; and
a processor configured to execute the one or more computer-readable instructions to perform one or more operations to:
receive, via the network interface, data from a service provider;
receive, via the microphone, a first user command, wherein the first user command comprises audio;
receive, via the camera, a second user command, wherein the second user comprises a visual movement;
output, to the display, the data;
providing a two-way wireless communication with an Internet of things (IoT) equipped device; and
control the IoT equipped device based, at least in part, on the first user command, the second user command or both.

2. The SMD of claim 1, the processor is further configured to execute the one or more computer-readable instructions to further perform the one or more operations to:
detect an activation command; and
activate in response to the activation command.

3. The SMD of claim 2, wherein the activation command is detected via the microphone, the camera, or both.

4. The SMD of claim 2, wherein the processor is further configured to execute the one or more computer-readable instructions to further perform the one or more operations to:
determine whether the activation command is associated with a smart assistant or a local function.

5. The SMD of claim 4, wherein the processor is further configured to execute the one or more computer-readable instructions to further perform the one or more operations to:
in response to the determination that the activation command is associated with the smart assistant, identify the smart assistant associated with the activation command, and wherein activating in response to the activation command comprises activating the smart assistant.

6. The SMD of claim 4, wherein the processor is further configured to execute the one or more computer-readable instructions to further perform one or more further operations to:
in response to the determination that the activation command is associated with the local function, provide an output command to a local device.

7. The SMD of claim 1, further comprising:
a voice privacy button, wherein the voice privacy button is an electronic persistent switch that does not allow for software control.

8. A method for receiving one or more commands by a smart media device (SMD), the method comprising:
receiving, via a network interface, data from a service provider;
receiving, via a microphone, a first user command of the one or more commands, wherein the first user command comprises audio;
receiving, via a camera, a second user command of the one or more commands, wherein the second user comprises a visual movement;
outputting, to a display, the data;
providing a two-way wireless communication with an Internet of things (IoT) equipped device; and
control, via an IoT controller of the SMD, the IoT equipped device based, at least in part, on the first user command, the second user command or both.

9. The method of claim 8, further comprising:
detecting an activation command; and
activating in response to the activation command.

10. The method of claim 9, wherein the activation command is detected via the microphone, the camera, or both.

11. The method of claim 10, wherein the microphone is controlled by a voice privacy button, wherein the voice privacy button is an electronic persistent switch that does not allow for software control.

12. The method of claim 9, further comprising:
determining whether the activation command is associated with a smart assistant or a local function.

13. The method of claim 12, further comprising:
in response to the determination that the activation command is associated with the smart assistant, identifying the smart assistant associated with the activation command, and wherein activating in response to the activation command comprises activating the smart assistant.

14. The method of claim 12, the method further comprising:
in response to the determination that the activation command is associated with the local function, providing an output command to a local device.

15. A non-transitory computer-readable medium of a smart media device (SMD) storing a program for receiving one or more commands, which when executed by a processor of the SMD, causes the SMD to perform one or more operations comprising:
receiving, via a network interface, data from a service provider;
receiving, via a microphone, a first user command of the one or more commands, wherein the first user command comprises audio;
receiving, via a camera, a second user command of the one or more commands, wherein the second user comprises a visual movement;
outputting, to a display, the data;
providing a two-way wireless communication with an Internet of things (IoT) equipped device; and
control the IoT equipped device based, at least in part, on the first user command, the second user command or both.

16. The non-transitory computer readable medium of claim 15, wherein the program, when further executed by the processor, causes the SMD to further perform the one or more operations comprising:
detecting an activation command; and
activating in response to the activation command.

17. The non-transitory computer readable medium of claim 16, wherein the activation command is detected via the microphone, the camera, or both.

18. The non-transitory computer readable medium of claim 17, wherein the microphone is controlled by a voice privacy button, wherein the voice privacy button is an electronic persistent switch that does not allow for software control.

19. The non-transitory computer readable medium of claim 16, wherein the program, when further executed by the processor, causes the SMD to further perform the one or more operations comprising:
determining whether the activation command is associated with a smart assistant or a local function; and
identifying the smart assistant associated with the activation command, and wherein activating in response to the activation command comprises activating the smart assistant.

20. The non-transitory computer readable medium of claim 19,
in response to the determination that the activation command is associated with the local function, providing an output command to a local device.
